(19) United States
(12) Patent Application Publication
(10) Pub. No.: US 2008/0185790 A1
(43) Pub. Date: Aug. 7, 2008

(54) Planar Seal

(76) Inventors: Martin Gasch, Hilden (DE); Markus Heilig, Betzdorf (DE); Ralf Flemming, Langenbach (DE)

Correspondence Address: Robert L. Stearns;Dickinson Wright PLLC, 38525 Woodward AV, Suite 2000, Bloomfield Hills, MI, 48304, US

(21) Appl. No.: 11/909,561

(22) PCT Filed: Feb. 2, 2006
(86) PCT No.: PCT/DE2006/000152

§ 371 Date: Sep. 24, 2007

(30) Foreign Application Priority Data
Mar. 23, 2005 (DE) 10 2005 013 416.5

(51) Int. Cl. F16J 15/08

(52) U.S. Cl. 277/595

(57) ABSTRACT

A planar seal, in particular, a cylinder head gasket for an internal combustion engine, is provided with several through openings forming a web between the same, several screw and media through openings, at least one bead in the region of each through opening and each web which are contiguous, whereby at least one through drilling is provided on the web side and embodied such that the beads on the through opening side pass to both sides of the through drilling in the direction of the web and are connected to the beads running through the web in the region of the web.

The invention relates to a planar seal, in particular a cylinder head gasket for an internal-combustion engine.

Planar seals, in particular cylinder head gaskets, contain a plurality of openings, such as for example combustion chamber through openings, screw- and media through-holes. If media through-holes, particularly holes which conduct cooling water, are provided in constricted areas such as, for example, in the web region between two through openings in the combustion chamber, particular steps must be taken on the seal side, in order to be able to realize this.

An additional aggravating factor is that in the web region, which is in any case already narrow, there are frequently also beads, particularly full beads, if necessary in combination with stopper elements lying adjacent thereto, so that on the seal side particular structural steps have to be taken. This is also with regard to additional media openings not impairing the gas seal.

From EP-A 0 597 353 a metal seal can be seen which is able to be used as a cylinder head gasket for an internal-combustion engine, having several combustion chamber through openings. In addition, a series of screw- and media through-holes are provided. This publication deals with the structural design of the bead guidance in the region of the web between combustion chamber through openings.

In U.S. Pat. No. 4,861,047 a metal plate is described which is able to be used as a cylinder head gasket and which has a similar construction to the document which has already been previously described. The tenor of this publication is the particular development of beads running into each other in the region of openings, formed in a rectangular shape, provided outside the combustion chamber through openings, for the passage of rods or suchlike.

The invention is based on the problem of providing a planar seal, in particular a cylinder head gasket for an internal-combustion engine, in which media through openings can be provided even in constricted regions which are provided with beads, without this having a disadvantageous effect for example on the gas sealing.

This problem is solved by a planar seal, in particular a cylinder head gasket for an internal-combustion engine, having several through openings, respectively forming a web between them, several screw and media through-holes, at least one bead in the region of the respective through opening and the respective web which are contiguous, whereby at least one through-bore is provided on the web side and embodied such that the beads on the through opening side pass to both sides of the through-bore in the direction of the web and are connected to the bead running through the web in the region of the web.

Advantageous further developments of the subject matter of the invention can be seen from the sub-claims.

With the subject matter of the invention, it is now possible to allow the full beads to run into each other at locations which can be preset in the narrow web region, such that the through bore is at least partially surrounded by the beads. Through this step—in so far as the planar seal is constructed as a cylinder head gasket—the gas sealing is not impaired.

For the respective case of application, planar seals having one or more layers can be used. To achieve the desired effect, it is merely necessary to carry out corresponding modifications at the areas at which the engine provides a web cooling, by shaping the full beads, particularly with regard to their radii, in order to deal with the specific case of application.

The subject matter of the invention is illustrated by means of an example embodiment in the drawings and is described as follows, in which:

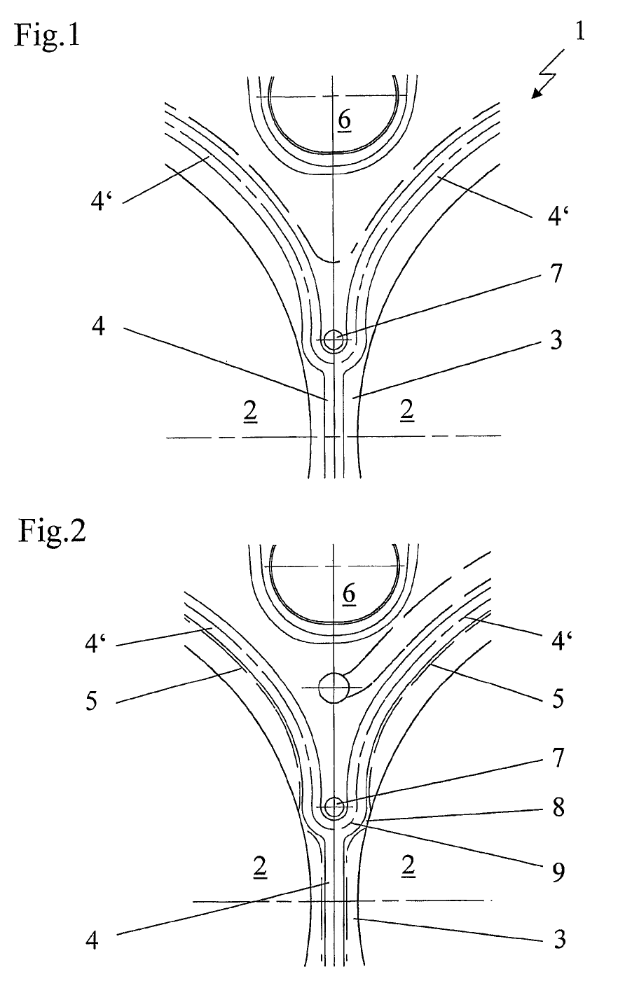

FIG. 1 shows a partial view of a planar seal which is able to be used as a cylinder head gasket, in top view;

FIG. 2 shows a partial view of an alternative planar seal which is able to be used as a cylinder head gasket, in top view.

FIG. 1 shows a partial view of a multi-layered cylinder head gasket 1, and namely the part on the web side between two through openings 2 which are formed as combustion chamber through openings. The web formed between the through openings 2 is given reference number 3. In this example, a layer of the planar seal 1 has on the one hand in the region of the web 3 a full bead 4 and on the other hand a further full bead 4′ associated with each through opening 2. In the embodiment according to FIG. 2, stopper elements 5 are arranged on the left and right adjacent to the respective full bead 4,4′. An oil through-hole 6 is merely indicated. If at least one further through-bore (punch hole) is now to be provided in the region of the web 3 for a motor which is equipped with web cooling, the following steps are provided in accordance with the invention: at least one through-bore 7 is introduced on the web side. The full beads 4′ are guided laterally past the through-bore 7 and then run into the bead 4 on the web side. The through-bore 7 is therefore surrounded by each bead 4′ with a looping angle >600.

In FIG. 2 an embodiment is illustrated in which a stopper element 5 in the region of the through-bore 7, respectively the lateral directing past of the respective bead 4′ in the transition region 9 is provided partially with a cut-out 8.

1. A planar seal having a plurality of through openings forming a web between them, a plurality of screw and media through-holes, at least one bead in the region of the respective through opening and the respective web which are contiguous, whereby at least one through-bore is provided on the web side and embodied such that the beads on the through opening side pass to both sides of the through-bore in the direction of the web and are connected to the bead running through the web in the region of the web.

2. The planar seal according to claim 1, wherein the beads are full beads.

3. The planar seal according to claim 1, wherein the through-bore is surrounded by the respective bead on the through opening side with a looping angle >60°.

4. The planar seal according to claim 1, wherein with the use of at least one of the stopper elements associated with the respective through opening, said element is constructed so as to be narrowed in a transition region of the beads on the through opening side into the bead on the web side.

5. The planar seal according to claim 1, wherein with the use of at least one of the stopper elements associated with the respective through opening, said element is provided on the through opening side at least partially with a cut-out in a transition region of the beads on the through opening side into the bead on the web side.
